(19) United States
(12) Patent Application Publication
(10) Pub. No.: US 2018/0287291 A1
(43) Pub. Date: Oct. 4, 2018

(54) CONNECTOR

(71) Applicants: Tetsuya KIFUNE, Tokyo (JP); Takaki TSUTSUI, Tokyo (JP); Taro MIZUE, Tokyo (JP)

(72) Inventors: Tetsuya KIFUNE, Tokyo (JP); Takaki TSUTSUI, Tokyo (JP); Taro MIZUE, Tokyo (JP)

(73) Assignee: MITSUMI ELECTRIC CO., LTD., Tokyo (JP)

(21) Appl. No.: 15/939,584

(22) Filed: Mar. 29, 2018

(30) Foreign Application Priority Data
Mar. 30, 2017 (JP) 2017-067596

(51) Int. Cl. H01R 13/52; H01R 13/73

(52) U.S. Cl. CPC H01R 13/5202; H01R 12/724; H01R 13/73; H01R 13/5219

(57) ABSTRACT

A connector includes: a main connector part including a housing in which a plurality of contacts are disposed side by side, the housing holding the plurality of contacts; and a shell to be disposed at least to an outer periphery of the housing, the shell including an opening in which a mating connector is to be inserted, the mating connector being a connection target for the plurality of contacts. In the connector, the shell includes an interlocking portion at an edge of the shell opposite to the opening in an insertion direction of the mating connector, the interlocking portion being adapted to restrict mutual movement of the shell and the main connector part along the insertion direction by being engaged with a portion of the housing transverse to the insertion direction of the mating connector.

### CROSS REFERENCE TO RELATED APPLICATIONS

This application is entitled to and claims the benefit of Japanese Patent Application No. 2017-067596, filed on Mar. 30, 2017, the disclosure of which including the specification, drawings and abstract is incorporated herein by reference in its entirety.

### TECHNICAL FIELD

The present invention relates to a waterproofed electronic part and connector.

### BACKGROUND ART

Traditionally, various types of connectors are incorporated into electronic devices, such as a mobile phone, personal digital assistant, portable music player, electronic book reader, and the like, for connecting the electronic devices to an external electronic device (see Patent Literatures (hereinafter, referred to as “PTLs”) 1 and 2).

In general, each of the connectors is fabricated from contact terminals and a metal shell by disposing the contact terminals in a housing made of resin and by surrounding the housing by the metal shell. In the connector, one ends of the contact terminals are disposed in the casing and the other ends are disposed to be oriented toward the outside of the casing.

This type of connector is fabricated generally by inserting, into the cylindrical shell, the housing inside which the contacts are disposed.

The housing and the shell are fixed to each other by inserting the housing into the shell, deforming a portion of the shell, and inserting this portion into a recess formed in the outer surface of the housing to relatively restrict the movement of the housing and the shell in the insertion-and-extraction direction.

### CITATION LIST

### Patent Literature

PTL 1:
Japanese Patent No. 5916197
PTL 2:
Japanese Patent Application Laid-Open No. 2015-5383

### SUMMARY OF INVENTION

### Technical Problem

However, the traditional connector in which the shell and the housing are fixed to each other by a claw portion formed from the deformed portion of the shell has a problem in that when the claw portion is not deformed enough in the deforming-and-engaging process of the claw portion, the engagement between the claw portion and the recess is made weak and such a weak engagement causes the shell and the housing to be disengaged during use, causing the housing to come out of the shell. Moreover, when the housing and the shell are wrenched in a fitting process or the like, the claw portion is easily deformed. This also causes the housing to come out of the shell.

Therefore, a structure making it less possible for the housing to come out of the shell has been desired.

An object of the present invention is to provide a connector in which it is made less possible for a housing to come out of a shell covering the housing.

### Solution to Problem

To achieve the above object, the present invention includes: a main connector part including a main connector part including a housing in which a plurality of contacts are disposed side by side, the housing holding the plurality of contacts; and a shell to be disposed at least to an outer periphery of the housing, the shell including an opening in which a mating connector is to be inserted, the mating connector being a connection target for the plurality of contacts. In the present invention, the shell includes an interlocking portion at an edge of the shell opposite to the opening in an insertion direction of the mating connector, the interlocking portion being adapted to restrict mutual movement of the shell and the main connector part along the insertion direction by being engaged with a portion of the main connector part transverse to the insertion direction.

### Advantageous Effects of Invention

According to the present invention, a connector in which it is made less possible for a housing to come out of a shell covering the housing can be achieved.

### BRIEF DESCRIPTION OF DRAWINGS

FIG. 1 illustrates a connector of one embodiment according to the present invention, as seen from the front end side of the connector;

FIG. 2 illustrates the connector of one embodiment according to the present invention, as seen from the right side of rear end of the connector;

FIG. 3 illustrates the connector of one embodiment according to the present invention, as seen from the right side surface of the connector;

FIG. 4 is an exploded view illustrating a structure of principal parts of the connector of one embodiment according to the present invention;

FIG. 5 is an exploded perspective view of a main connector part corresponding to a part of the connector of one embodiment according to the present invention from which a gasket and an outer mold are detached;

FIG. 6A illustrates the main connector part, particularly the right side surface of the main connector part;

FIG. 6B illustrates the main connector part, particularly the right side surface of the main connector part from which an elastic sealing material is detached;

FIG. 7 illustrates a bottom housing as seen from below;

FIG. 8 is a bottom view of a top housing;

FIG. 9 is a sectional view taken along line C-C and seen in the direction indicated by the arrows in FIG. 3;

FIG. 10 is a sectional view taken along line D-D and seen in the direction indicated by the arrows in FIG. 3;

FIG. 11 is a sectional view taken along line A-A in FIG. 1;

FIG. 12 is a sectional view taken along line B-B in FIG. 1;

FIG. 13 illustrates Modification 1 of the elastic sealing material;

FIG. 14 illustrates Modification 2 of the elastic sealing material;

FIG. 15 illustrates Modification 3 of the elastic sealing material;

FIG. 16 illustrates Modification 4 of the elastic sealing material;

FIG. 17 is a rear view of Modification 5 of the elastic sealing material;

FIG. 18 illustrates the connector of one embodiment according to the present invention, as seen from below;

FIG. 19 is an explanatory view of interlocking portions of the connector illustrated in FIG. 18 from which the gasket is detached;

FIG. 20 is an explanatory view of Modification 1 of the state where the outer mold and the shell are interlocked;

FIG. 21 is an explanatory view of Modification 2 of the state where the outer mold and the shell are interlocked;

FIG. 22 is an explanatory view of Modification 3 of the state where the outer mold and the shell are interlocked;

FIG. 23 is an explanatory view of Modification 4 of the state where the outer mold and the shell are interlocked;

FIG. 24A-D illustrate a method for assembling the connector of one embodiment according to the present invention; and

FIG. 25 illustrates an electronic device in which the connector of one embodiment according to the present invention is mounted.

### DESCRIPTION OF EMBODIMENTS

Hereinafter, an embodiment of the invention will be described in detail with reference to the accompanying drawings.

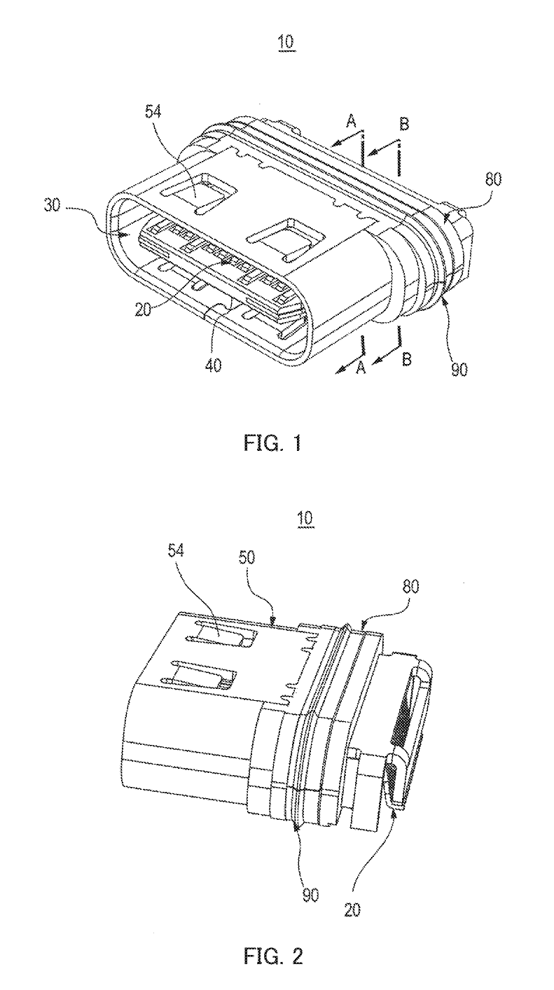

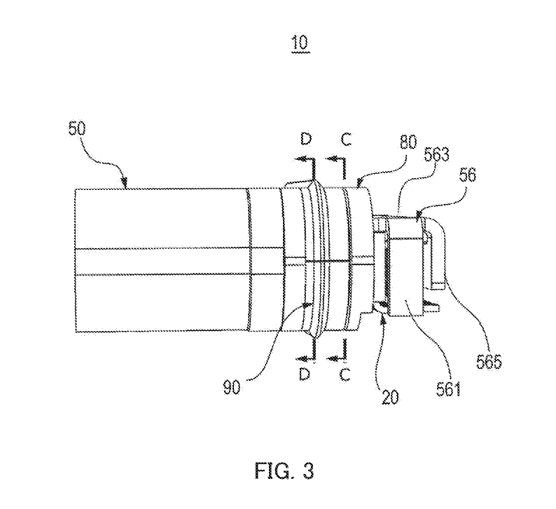

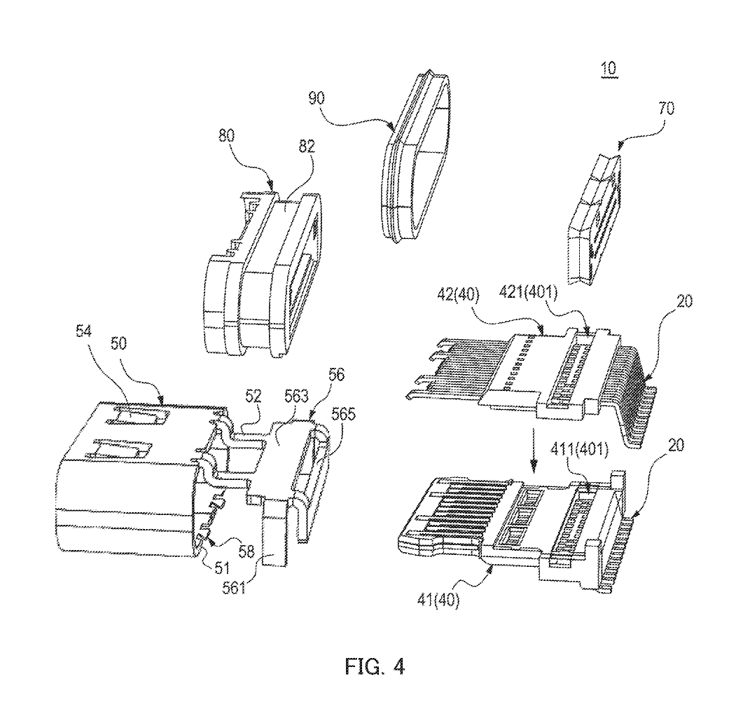

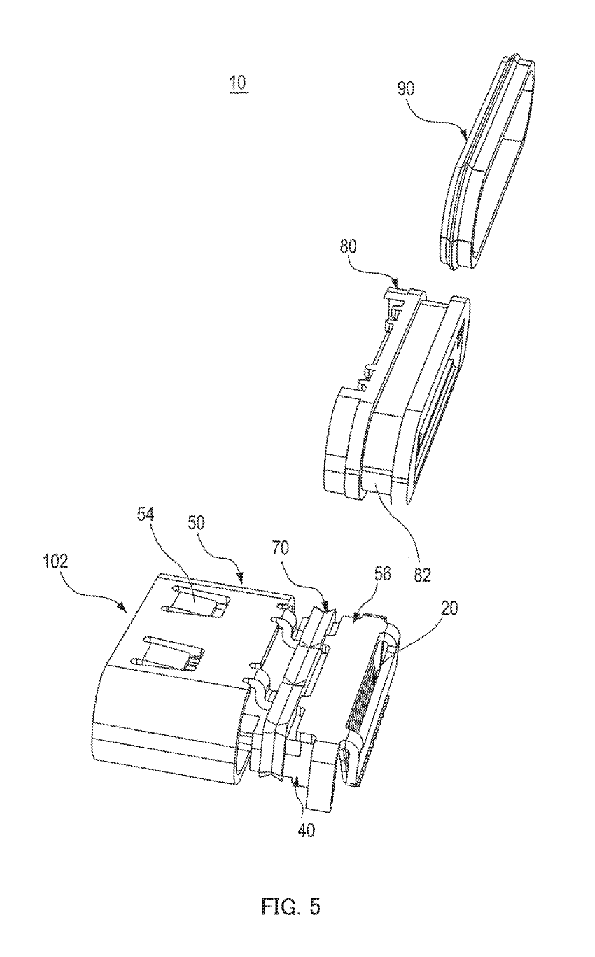

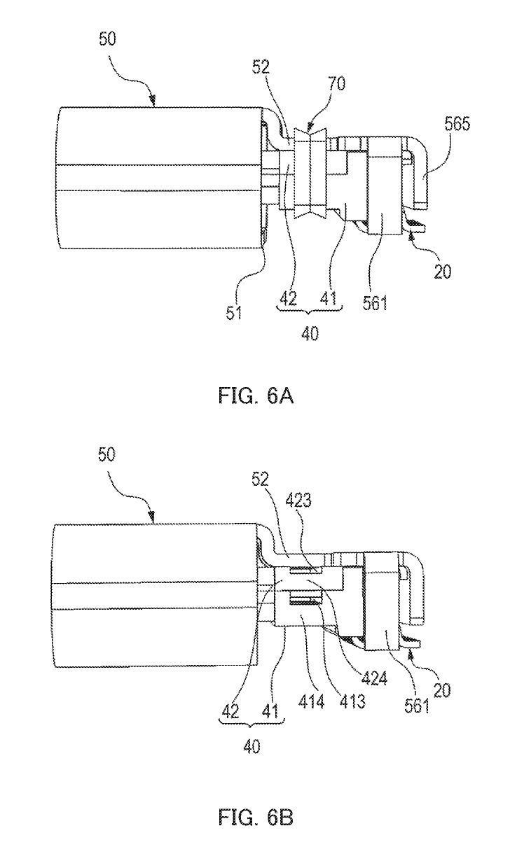

FIG. 1 illustrates a connector of one embodiment according to the present invention, as seen from the front end side of the connector, FIG. 2 illustrates the connector of one embodiment according to the present invention, as seen from the right side of rear end of the connector, and FIG. 3 illustrates the connector of one embodiment according to the present invention, as seen from the right side surface of the connector. In addition, FIG. 4 is an exploded view illustrating a structure of principal parts of the connector of one embodiment according to the present invention, FIG. 5 is an exploded perspective view of a main connector part corresponding to a part of the connector of one embodiment according to the present invention from which a gasket and an outer mold are detached, FIG. 6A illustrates the main connector part, particularly the right side surface of the main connector part; and FIG. 6B illustrates the main connector part, particularly the right side surface of the main connector part from which an elastic sealing material is detached. Note that, expressions related to directions, such as front, rear, right, and left as used in the embodiment of the present invention are not absolute, but relative, and these expressions respectively mean the front surface, rear surface, right side surface, and left side surface as seen from the side of a connector portion to be connected to a mating connector.

<Entire Structure of Connector 10>

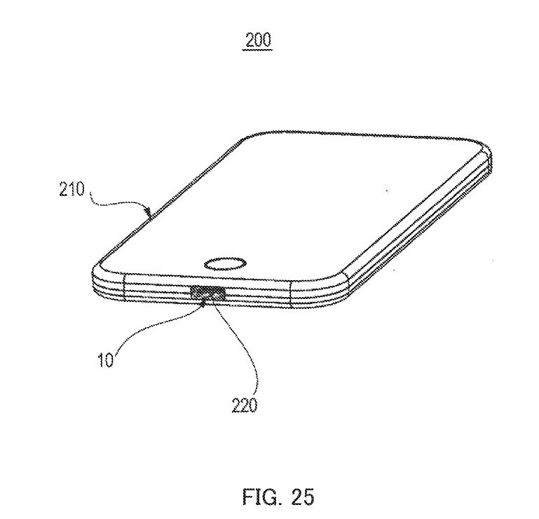

Connector 10 of the embodiment according to the present invention is a waterproofed connector, so-called waterproof connector, and is used for electronic device 200 (see FIG. 25), such as a mobile phone, personal digital assistant, portable music player, electronic book reader, or the like, for example. The connector according to the embodiment of the present invention may be a waterproof connector such as that conforming to USB standards. For example, the connector of the embodiment of the present invention is applicable as the USB Type-C connector or the like.

Connector 10 illustrated in FIGS. 1 to 4 is an electronic part, and includes a plurality of contacts 20, housing 40, shell 50, elastic sealing material 70, outer mold 80, and gasket 90. Shell 50 of connector 10 covers housing 40 (particularly, the front end of housing 40) that is an insulator adapted to support contacts 20 that are conductive members.

In connector 10, cylindrical shell 50 is disposed to the outer periphery of the front end of housing 40 supporting contacts 20, and elastic sealing material 70 is disposed to a part of housing 40 in such a manner as to surround respective portions of contacts 20 while in tight contact with these portions, as illustrated in FIGS. 1 to 6. Elastic sealing material 70 encloses therein portions of coupling arms 52 protruding from shell 50 on the rear end side of shell 50. Outer mold 80 is provided to the outer periphery of elastic sealing material 70, and gasket 90 is attached to the outer surface of outer mold 80. Outer mold 80 is disposed on the rear end side of housing 40 such that relative movement of outer mold 80 to housing 40 in the insertion direction of the mating connector is restricted. Outer mold 80 is disposed integrally to surround the outer periphery of the rear portion of housing 40 in the embodiment of the present invention. Note that, a main connector part is composed of housing 40 and outer mold 80.

<Structure of Principal Parts of Connector 10>

Each of the plurality of contacts 20 is a long filamentary material made of a highly conductive metal and includes one end to be connected to a contact of a mating connector (another electronic part) and the other end to be connected to a connection target for the mating connector.

Contacts 20 are supported by housing 40 such that one ends respectively including contact points are disposed on the front end side, the other ends are disposed on the rear end side, and contacts are spaced from each other in the right-left direction at predetermined intervals. The plurality of contacts 20 are composed of two upper and lower rows of contacts and the upper and lower rows of contacts are disposed symmetrically in housing 40 in the embodiment of the present invention. However, the present invention is not limited to this embodiment, and a plurality of contacts 20 composed of one row of contacts or three or more rows of contacts may be disposed in housing 40. In addition, the number of contacts in each of the rows may be any number.

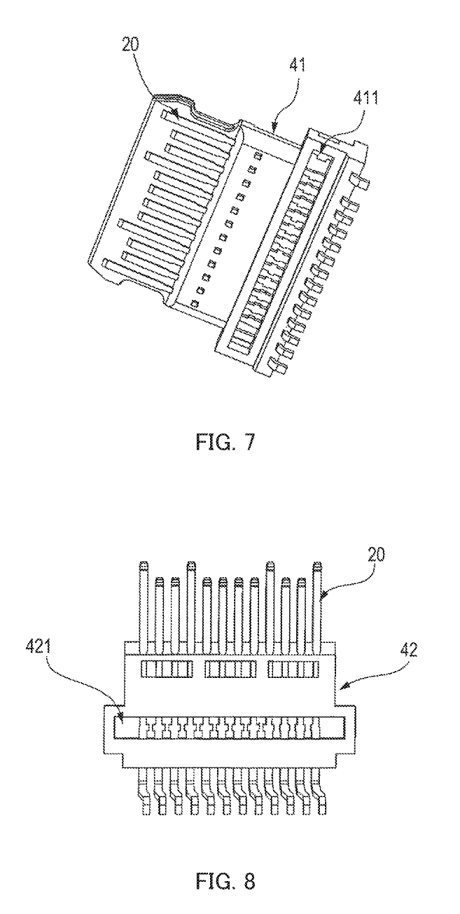

FIG. 7 illustrates bottom housing 41 as seen from below, and FIG. 8 is a bottom view of top housing 42.

Housing 40 includes bottom housing 41 and top housing 42 in the embodiment of the present invention, as illustrated in FIGS. 4 and 6 to 8. Note that, a portion of housing 40 enclosing portions between the one ends and the other ends of contacts 20 corresponds to the front end of housing 40.

As illustrated in FIGS. 4 and 7, bottom housing 41 is flat and platelike and is formed to create a watertight structure in which multiple contacts 20 of the lower row are fit in multiple grooves extending in the front-rear direction.

Bottom housing 41 is formed from a polyamide-based resin, for example, nylon (registered trademark). Bottom housing 41 and the lower row of contacts 20 are formed integrally using insert molding in the present embodiment. This brings bottom housing 41 and contacts 20 supported by bottom housing 41 into tight contact with each other.

Through hole 411 extending perpendicular to the extending direction of contacts 20, that is, to the longitudinal direction is formed in bottom housing 41. In this embodiment, through hole 411 is formed perpendicular to the extending direction of contacts 20 and formed in the form of a slit. In through hole 411, contacts 20 are provided to cross through hole 411 in the transverse direction of through hole 411, and are exposed to the outside in bottom housing 41. These contacts 20 within through hole 411 are each formed to be provided with protrusions at the outer surface of contact 20 so that the width of contact 20 is not constant for lengthening the distance of contact 20 in the longitudinal direction and accordingly the water ingress is made less possible.

In addition, as illustrated in FIGS. 4 and 8, top housing 41 is flat and platelike and is formed to create a watertight structure in which multiple contacts 20 of the upper row are fit in multiple grooves extending in the front-rear direction.

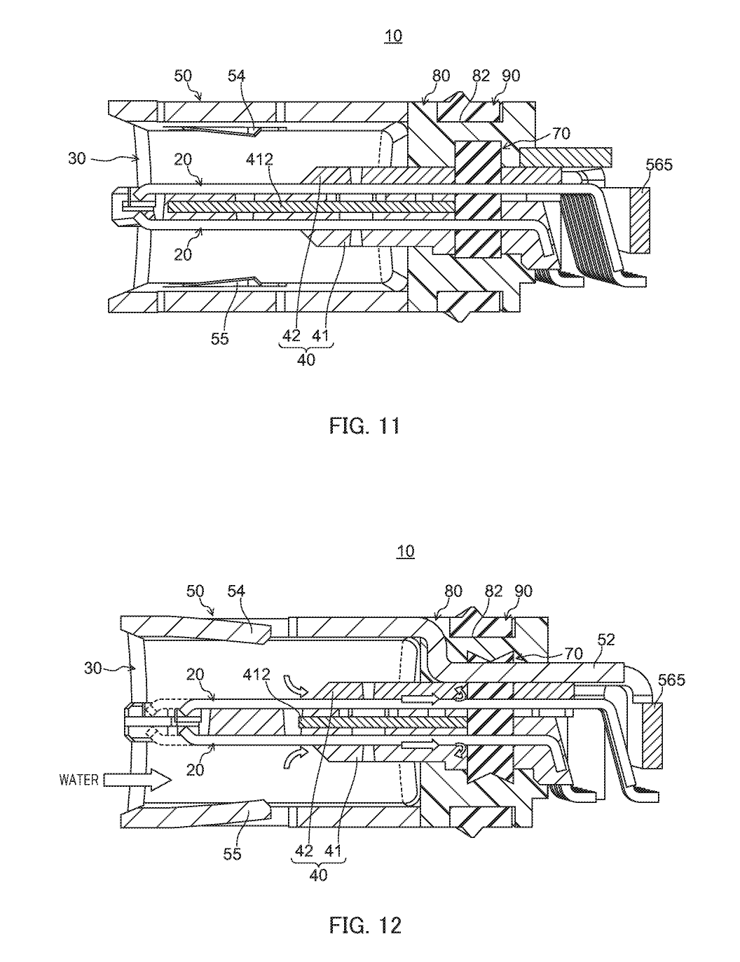

Note that, platelike reinforcing board 412 adapted to reinforce the front end side of bottom housing 41 (that is, of housing 40) is provided inside bottom housing 41 on the front end side (see FIGS. 11 and 12). With this reinforcing board 412, insertion of connector 10 into a mating connector can easily be guided and thus the contacts of both of the connectors can easily be connected to each other without causing bottom housing 41 to be bent on the front end side when connector 10 is fit in the mating connector and the front end side of bottom housing 41 is inserted in a recess in the mating contact.

Top housing 42 is formed from a polyamide-based resin, for example, nylon. Top housing 42 and the upper row of contacts 20 are formed integrally using insert molding in the present embodiment. This brings top housing 42 and those contacts 20 supported by top housing 42 into tight contact with each other.

Through hole 421 extending perpendicular to the extending direction of contacts 20, that is, to the longitudinal direction is formed in top housing 42. In this embodiment, through hole 421 is formed perpendicular to the extending direction of contacts 20 and formed in the form of a slit. In through hole 421, contacts 20 are provided to cross through hole 411 in the transverse direction of through hole 421, and are exposed to the outside in top housing 42. These contacts 20 within through hole 421 are each formed to be provided with protrusions at the outer surface of contact 20 so that the width of contact 20 is not constant for lengthening the distance of contact 20 in the longitudinal direction and accordingly the water ingress is made less possible.

Housing 40 is formed by placing these bottom and top housings 41 and 42 on each other, as illustrated in FIGS. 4 and 6. When bottom and top housings 41 and 42 are placed on each other, through holes 411 and 421 formed to correspond to each other form opening 401 passing through housing 40 in the up-down direction in a portion of housing 40 on the rear end side.

The plurality of contacts 20 are disposed crosswise in opening 401 in housing 40. Elastic sealing material 70 is provided in opening 401, and each of contacts 20 in opening 401 is covered by elastic sealing material 70 while the periphery of contact 20 (the outer periphery of contact 20 in opening 401) is in tight contact with elastic sealing material 70.

In addition, gutter portions 413 and 423 are formed in the upper surfaces of both side wall portions 414 and 424 of through holes 411 and 421 in bottom and top housings 41 and 42 in such a manner as to extend laterally through side wall portions 414 and 424, respectively, as illustrated in FIG. 6B.

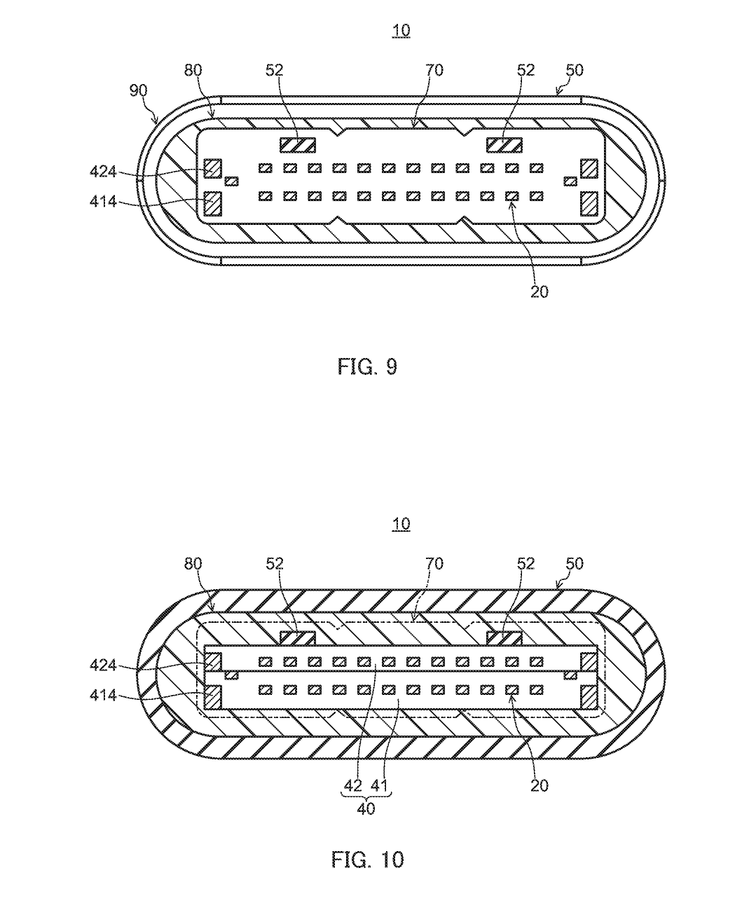

FIG. 9 is a sectional view taken along line C-C and seen in the direction indicated by the arrows in FIG. 3, and FIG. 10 is a sectional view taken along line D-D and seen in the direction indicated by the arrows in FIG. 3.

As illustrated in FIGS. 4 to 6, 9, and 10, elastic sealing material 70 comes into tight contact with and covers, on the rear end side of housing 40, portions of housing 40 and contacts 20 supported by housing 40, that is, the outer peripheries of the portions of housing 40 and contacts 20 around which elastic sealing material 70 is disposed.

Elastic sealing material 70 is formed from elastic soft resin, such as an elastomeric resin or the like. Elastic sealing material 70 is formed, for example, from polyester-based thermoplastic elastomer (TPEE). Elastic sealing material 70 is rectangular, has a predetermined thickness (length in the front-rear direction of connector 10), and is formed by molding in the embodiment of the present invention.

As illustrated in FIGS. 4 to 6, 9, and 10, elastic sealing material 70 encloses portions between one ends and the other ends of contacts 20 while being in tight contact with the outer peripheries of these portions. Elastic sealing material 70 also encloses portions of bottom and top housings 41 and 42 positioned between one ends and the other ends of contacts 20 (both side wall portions 414 and 424) while being in tight contact with these portions.

In this way, elastic sealing material 70 encloses portions of housing 40 while being in tight contact with the peripheries of these portions; these portions are portions (side wall portions 414 and 424 having gutter portions 413 and 423 at their tops, respectively) at which one portion of housing 40 on the one end side, which corresponds to the housing main body, is connected to the other portion of housing 40 on the rear end side. Elastic sealing material 70 also encloses portions of coupling arms 52 protruding from the edge (the upper surface of the edge) on the rear side of shell 50 while being in tight contact with these portions.

In this way, in connector 10, elastic sealing material 70 is disposed perpendicular to the extending direction of connector 10 and disposed on the outer peripheral surfaces of all members of connector 10 that extend on the one end side and other end side and that are possible paths of water ingress from the outside into the inside of connector 10, so as to block the paths of water ingress.

Note that, elastic sealing material 70 may have any shape which allows elastic sealing material 70 to be provided between one ends (front ends) and the other ends (base ends) of contacts 20, to come into tight contact with the outer surfaces of contacts 20, and to prevent water ingress due to the capillarity along the outer surfaces of contacts 20 from the front end side to the base end side.

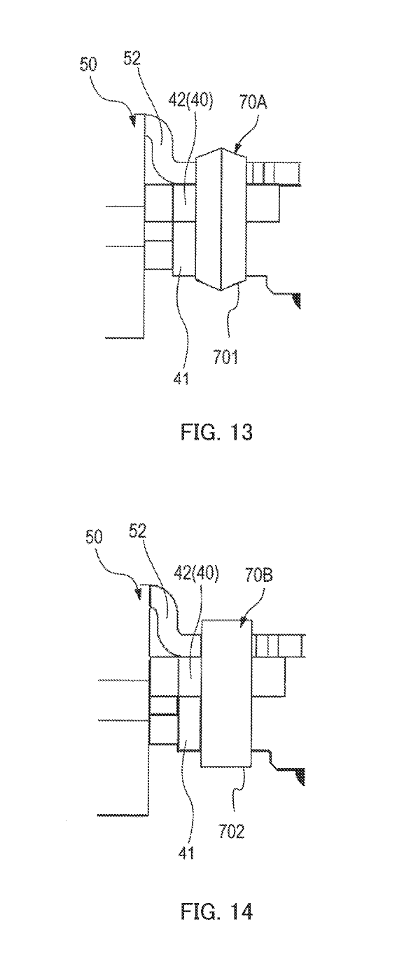

Examples of modified elastic sealing material 70 are illustrated in FIGS. 13 to 17.

Outer surface 701 of elastic sealing material 70A illustrated in FIG. 13 is formed in the shape of a mountain having a peak in the middle portion in the front-rear direction. Outer surface 702 of elastic sealing material 70B illustrated in FIG. 14 is formed flat.

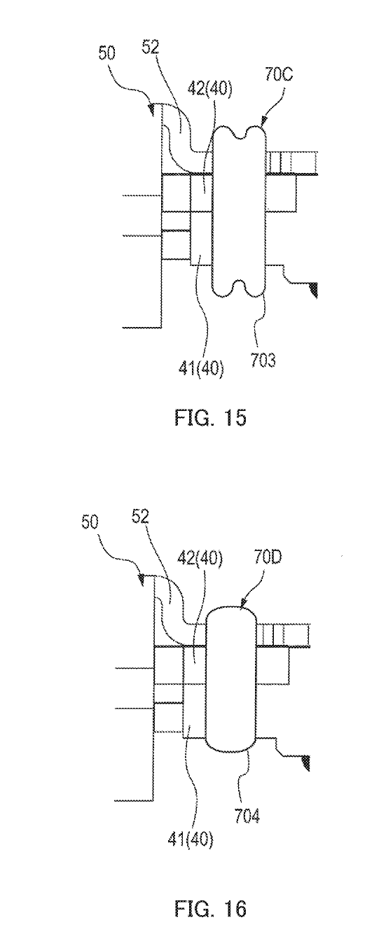

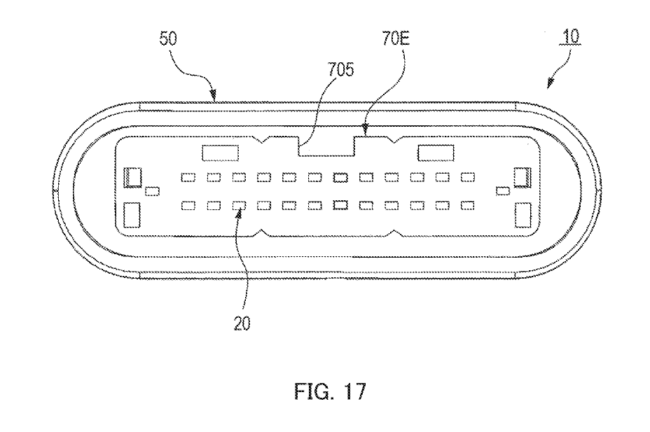

Outer surface 703 of elastic sealing material 70C illustrated in FIG. 15 is formed by a plurality of curved surfaces. Outer surface 704 of elastic sealing material 70D illustrated in FIG. 16 is a curved surface. As for the shape of elastic sealing material 70E illustrated in FIG. 17, cutout 705 is formed in a part of the outer surface.

Every one of elastic sealing materials 70A to 70E can produce the same effect as elastic sealing material 70. In particular, elastic sealing materials 70A, 70C, and 70E illustrated in FIGS. 13, 15, and 17 have a deformed shape such as a protrusion at a part of the outer surface or the like, so that respective outer molds 80 for covering these elastic sealing materials 70A, 70C, and 70E can be interlocked easily with and joined firmly to these elastic sealing materials 70A, 70C, and 70E when outer molds 80 are provided by molding.

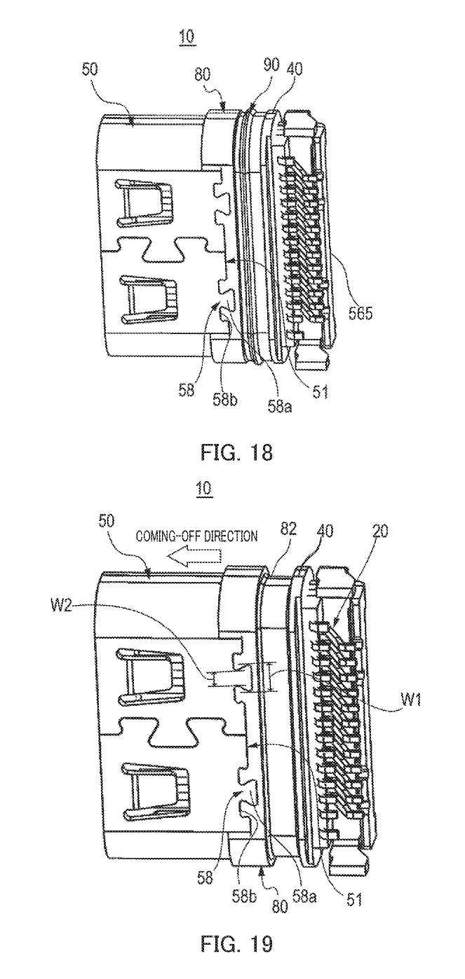

FIG. 18 illustrates the connector of one embodiment according to the present invention, as seen from below.

As illustrated in FIGS. 1 to 6 and 9 to 12, shell 50 is cylindrical and, as for shell 50 formed, for example, by processing a flat metal plate is conductive in the embodiment of the present invention.

Shell 50 is disposed to surround the front end side of housing 40 supporting contacts 20, and a mating connector (for example, plug) is inserted from the side of an opening of shell 50. To be more specific, shell 50 includes opening 30 in which a mating connector being a connection target for contacts 20 is inserted.

As illustrated in FIGS. 1 to 6, 9 to 12, and 18, shell 50 includes, at a pair of mutually opposing surfaces (the upper and lower surfaces of shell 50 in the embodiment of the present invention), plate springs (shell springs) 54 and 55 formed by cutting the upper and lower surfaces and by causing the cut upper and lower surfaces to stand inward.

Shell springs 54 and 55 are adapted to be engaged with a shell of the mating connector when connector 10 is connected to the mating connector. Shell 50 is grounded on a substrate or the like (not illustrated) via legs formed continuously from the rear end of shell 50. Shell 50 in the embodiment of the present invention is provided with rear shell portion 56 continuously via coupling arms 52 protruding rearward from shell 50 on the rear end side.

Shell 50 includes, at rear edge 51, interlocking portions 58 formed to be interlocked with outer mold 80 so as to prevent shell 50 from coming off outer mold 80 (see FIGS. 18 and 19).

In the embodiment of the present invention, each of interlocking portions 58 is rugged and includes protrusion 58a and recesses 58b, and is formed to be coupled with outer mold 80 by means of a so-called dovetail joint. The details about this interlocking portion 58 are described below.

Rear shell portion 56 includes main plate portion 563 continuing from coupling arms 52, legs 561 extending downward from main plate portion 563, and back shield portion 565.

Main plate portion 563 is formed to cover the rear ends of contacts 20 at a position above the rear ends of contacts 20. Main plate portion 563 is located lower than the upper surface of shell 50 as is apparent from FIG. 4. With this structure, the outer surface of outer mold 80, outer mold 80 being adapted to surround coupling arms 52 that are located as high as main plate portion 563, can be made substantially flush with the outer surface of shell 50, so that connector 10 can be miniaturized without an increase in outer diameter of connector 10 being caused.

Top housing 42 of housing 40 is disposed along the undersurfaces of coupling arms 52. Accordingly, coupling arms 52 function as a positioning guide during insertion of housing 40 into shell 50.

Legs 561 serve as legs for fixation in attaching connector 10 to a mounting board or the like, and can be connected to a ground on the mounting board to ground shell 50.

Back shield portion 565 is formed by bending downward a platelike portion extending out from the rear part of main plate portion 563.

That is, shell 50 has a function of covering the outer periphery of housing 40, and also covers the rear end side of contacts 20 with back shield portion 565 at the rear portion of connector 10 so as to allow improvement of noise immunity of connector 10.

<Interlocking Portion 58>

FIG. 19 is an explanatory view of interlocking portion 58 of connector 10 illustrated in FIG. 18 from which gasket 90 is detached.

Interlocking portion 58 is situated at edge 51 of shell 50 that is opposite to opening 30 in the insertion direction of the mating connector, and is engaged with a portion of the main connector part transverse to the insertion direction of the mating connector, so as to restrict mutual movement of shell 50 and the main connector part (housing 40) along the insertion direction.

As illustrated in FIG. 19, in interlocking portion 58, protrusion 58a has a size (W1) in the direction perpendicular to the coming-off direction on the front end side and a size (W2) in the direction perpendicular to the coming-off direction on the rear end side, and size W1 is greater than size W2. That is, interlocking portion 58 includes protrusion 58a extending in the insertion direction of the mating connector, and this protrusion 58a includes a portion transverse to the insertion direction, which is formed such that the width of this portion is greater on the front end side than at the base end side of this portion.

Because of the shape of interlocking portion 58 at edge 51 of shell 50, a portion of outer mold 80 to be joined to edge 51 comes to have an interlocking shape corresponding to the shape of interlocking portion 58 when outer mold 80 is formed from resin (for example, nylon) by out-mold molding. That is, outer mold 80 is engaged with interlocking portion 58 of shell 50 to conform to interlocking portion 58. This prevents the relative movement of outer mold 80 and shell 50 in the coming-off direction (direction indicated by the arrow in FIG. 19).

Interlocking portion 58 may have any shape which restricts the relative movement of shell 50 and outer mold 80 in the coming-off direction.

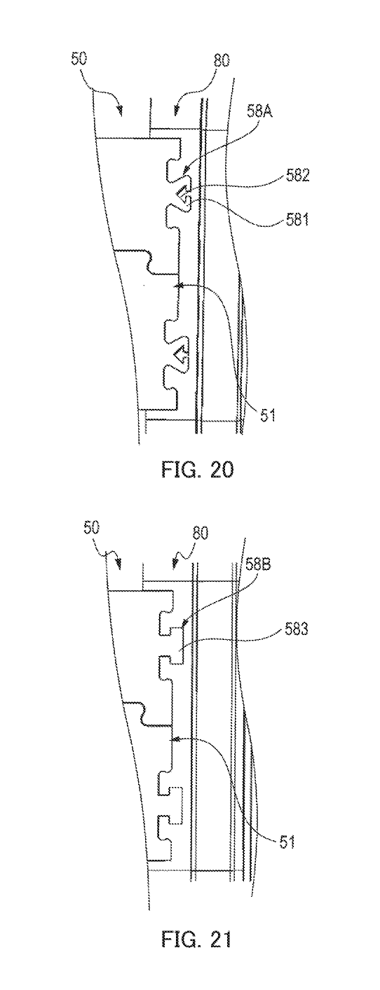

Interlocking portion 58A of Modification 1 illustrated in FIG. 20 includes, in protrusion 581 of shell 50, recess 582 that is open on the side of outer mold 80. Recess 582 is formed in the shape of an inverse arrow and a protrusion of outer mold 80 that is to be fit in this recess 582 is formed in the shape of an arrow, so that outer mold 80 is engaged with recess 582 by an arrowhead portion of the protrusion of outer mold 80 and the relative movement in the coming-off direction is restricted.

In interlocking portion 58B of Modification 2 illustrated in FIG. 21, protrusion 583 of shell 50 is T-shaped and, at the tip end of protrusion 583, a straight portion projecting rightward and leftward to extend perpendicular to the protruding direction of protrusion 583 is formed. A recess in outer mold 80 to be engaged with this protrusion 583 has a bent shape like a hook at the opened edge portion of the recess, so that shell 50 and outer mold 80 are engaged with each other and the relative movement in the coming-off direction is restricted.

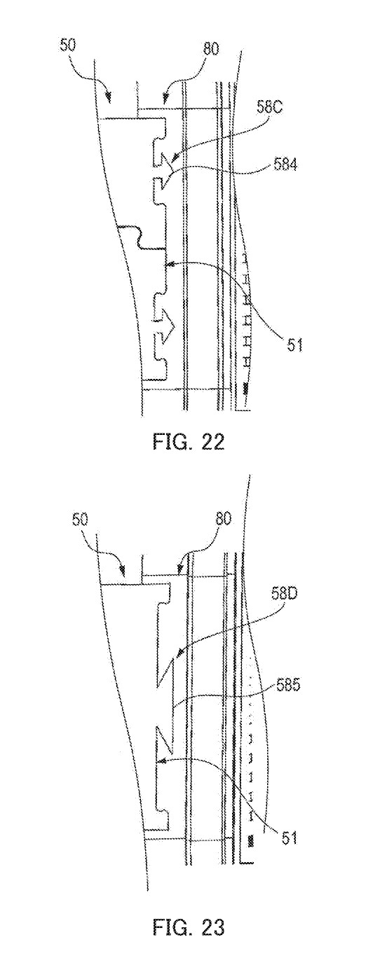

Further, in interlocking portion 58C of Modification 3 illustrated in FIG. 22, protrusion 584 of shell 50 has a size in the widthwise direction (in the right-left direction of the connector) greater on the base end side than on the front end side. That is, protrusion 584 is formed in the shape of an arrow pointing the side of outer mold 80. Accordingly, a portion of outer mold 80 is engaged with the arrowhead portion of arrow-shaped protrusion 584, so that shell 50 and outer mold 80 are engaged with each other and the relative movement in the coming-off direction is restricted.

As illustrated in interlocking portion 58D of Modification 4 in FIG. 23, protrusion 585 of shell 50 may be formed in the shape of an inverse triangle or the like. In this case, the recess of outer mold 80 is engaged with this protrusion 585, so that shell 50 and outer mold 80 are engaged with each other and the relative movement in the coming-off direction is restricted.

In this way, protrusions 58a, 581, 583, 584, and 585 of interlocking portions 58 and 58A to 58D may have any shape which allows the interlocking portion to be engaged with a mating recess such that the relative movement in the coming-off direction is restricted. This prevents shell 50 from coming off outer mold 80.

In main connector part 102, outer mold 80 is disposed between shell 50 and rear shell portion 56 in a solid state in such a manner as to surround elastic sealing material 70, and is formed integrally with housing 40.

Outer mold 80 is formed from a polyamide-based resin, for example, nylon (registered trademark) and is provided by molding in the embodiment of the present invention to encapsulate elastic sealing material 70.

The outer surface of outer mold 80 is formed substantially flush with the outer surface of shell 50.

Annular recess 82 is formed in the outer surface of outer mold 80 in the circumferential direction, and gasket 90 is attached to the outside of this recess 82. Gasket 90 allows airtight attachment of connector 10 to an opening of an electronic device, which is a connector attachment port, (for example, opening 220 in FIG. 25) when connector 10 is attached to this opening.

Note that, although the number of coupling arms 52 is two in the embodiment of the present invention, the present invention is not limited to this number and the number of coupling arms 52 may also be one. Coupling arms 52 in the embodiment of the present invention are disposed to overlap particularly with some of contacts 20 that transmit high speed signals, in which case coupling arms overlap with such contacts 20 in the extending direction of such contacts 20. This makes it possible to remove noise (EMI) during transmission and reception of the high speed signals, for example.

<Example of Method for Producing Connector>

Connector 10 of the embodiment of the present invention can be produced using any suitable method for producing connector 10.

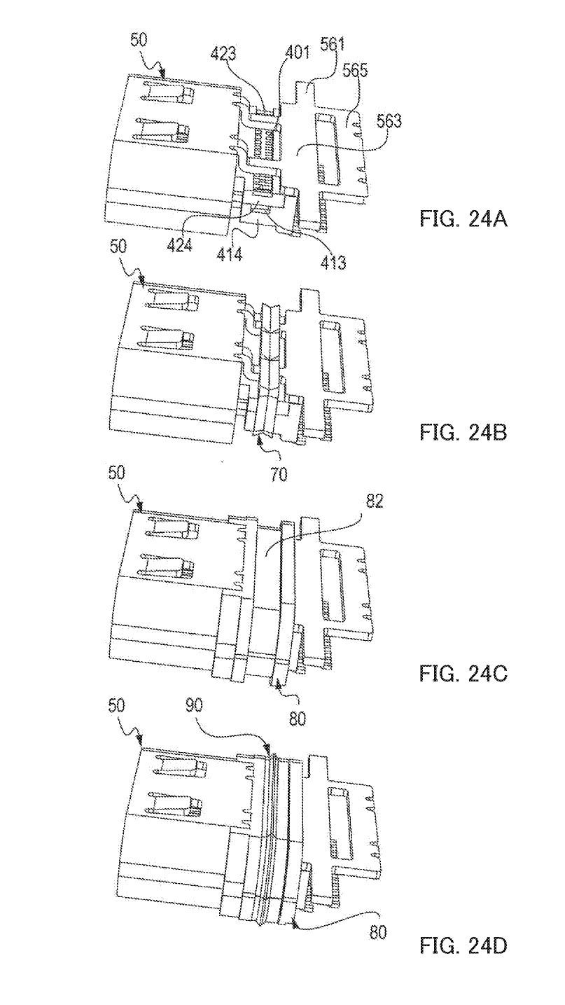

FIG. 24 illustrates a method for assembling the connector of one embodiment according to the present invention. To begin with, for example, bottom housing 41 and top housing 42 are produced by disposing contacts 20 corresponding to metal molds (not illustrated) of bottom housing 41 and top housing 42, respectively, and by pouring resin, such as a nylon resin or the like, into the peripheries of contacts 20 to perform insert molding.

In addition, shell 50 with rear shell portion 56 is produced by processing a metal plate. The back shield and legs as well as rear shell portion 56 is flat and platelike. Bottom housing 41 and top housing 42 are joined to form housing 40, and housing 40 is inserted into shell 50 from the rear side of shell 50 (see FIG. 24A).

Then, elastic sealing material 70 is formed from an elastomeric resin by molding to close opening 401 of housing 40.

At this time, the resin flows through gutter portions 413 and 423 formed in the upper surface of both side wall portions 414 and 424 of through holes 411 and 421 that form opening 401 in bottom housing 41 and top housing 42 of housing 40, and opening 401 is filled with the resin. In this way, elastic sealing material 70 in tight contact with the outer peripheries of all the contacts 20 within opening 401 is formed by molding. In addition, elastic sealing material 70 is provided in such a manner as to surround parts of the outer peripheries of coupling arms 52 extending from shell 50, to be in tight contact with those parts, and to be solid. In this way, all the portions that can be a path of water ingress into connector 10 from the front end side to the rear end side of connector 10 are blocked by a single molding process.

Then, outer mold 80 is formed by molding to encapsulate elastic sealing material 70 as illustrated in FIG. 24C. At this time, outer mold 80 is formed by molding to conform to interlocking portions 58 of shell 50, and is thus formed to restrict movement in the coming-off direction.

Then, gasket 90 is attached to the outside of recess 82 in outer mold 80 as illustrated in FIG. 24D. Subsequently, back shield portion 565 and legs 561 are bent downward. Connector 10 is thus formed.

According to connector 10 of the embodiment of the present invention, when a large amount of water ingresses first through the opening as illustrated in FIG. 12, the water attached to housing 40 (in particular, to bottom housing 41 and top housing 42) in shell 50 may ingress into the gaps between housing 40 and contacts 20 due to capillarity in a region of housing 40 that holds contacts 20. This occurs even when housing 40 and contact 20 are brought into tight contact with each other by insert molding. In addition, water may travel along shell 50 to ingress into connector 10 on its rear end side.

The water that ingresses into the gaps between housing 40 and contacts 20 moves toward the rear end side, that is, moves inward within the gaps along contacts 20 and portions of housing 40 facing contacts 20. However, in connector 10, elastic sealing material 70 interrupts the continuity of the gaps extending in the front-rear direction between housing 40 and contacts 20, so that it is possible to prevent inward water ingress, and therefore, the water ingress into connector 10 does not occur.

In this way, the length of the connector in the front-rear direction can be reduced and it is ensured that the water ingress into the connector can be prevented in comparison with the traditional structures in which a path of water ingress is lengthened to prevent the water ingress into the connector.

FIG. 25 is a perspective view of electronic device 200 provided with connector 10 of the embodiment of the present invention.

Electronic device 200 includes hollow device casing 210 and connector 10.

Device casing 210 is formed to include a sealed hollow portion; for example, includes upper and lower casings and a packing tightly held between the mating surfaces of the upper and lower casings. Device casing 210 includes opening 220 for a connector to be disposed therein that is formed in the outer surface of device casing 210, and connector 10 is disposed in this opening 220.

Connector 10 is disposed in opening 220 such that the opening in connector 10 is oriented outward, and is attached to device casing 210 by gasket 90 in an airtight manner.

In electronic device 200, device casing 210 is sealed and connector 10 is fixed in opening 220 via gasket 90, so that water, dust, or the like does not ingress into electronic device 200 between device casing 210 and connector 10.

In addition, in the inside of connector 10, possible paths of water ingress into connector 10 due to capillarity, such as contacts 20, coupling arms of shell 50, and the like, are blocked by elastic sealing material 70 encapsulated in outer mold 80 to which gasket 90 is fit as described above. This makes it possible to improve further the waterproofness of electronic device 200 provided with connector 10. According to connector 10 provided with shell 50, it is thus possible to achieve miniaturization and to prevent water ingress with a simple structure.

The embodiment disclosed herein is merely an exemplification in every respect and should not be considered as limitative. The scope of the present invention is specified by the claims, not by the above-mentioned description. The scope of the present invention is intended to include all modifications in so far as they are within the scope of the appended claims or the equivalents thereof.

The embodiments of the invention have been described above. The above description is an illustration of the preferred embodiment of the present invention, and the scope of the present invention is not limited to the description. That is, the description for the construction of the above-mentioned device and for the shape of each part is an example, and it is clear that various modifications and additions to the example can be made within the scope of the present invention.

### INDUSTRIAL APPLICABILITY

A connector according to the present invention has an effect in which it is ensured that water ingress into the connector can be prevented with a simple structure, and the connector is useful as a waterproof connector.

### REFERENCE SIGNS LIST

10 Connector
20 Contact
30, 220, 401 Opening
40 Housing
41 Bottom Housing
42 Top Housing
50 Shell
52 Coupling Arm
56 Rear Shell Portion
58, 58A, 58B, 58C, 58D Interlocking Portion
70, 70A, 70B, 70C, 70D, 70E Elastic Sealing Material
80 Outer Mold
82 Recess
90 Gasket
102 Main Connector Part
200 Electronic Device
210 Device Casing
411, 421 Through Hole
412 Reinforcing Board
413, 423 Gutter Portion
561 Leg
563 Main Plate Portion
565 Back Shield Portion
581, 583, 584, 585, 58a Protrusion
582 Recess
701, 702, 703, 704 Outer Surface
705 Cutout

1. A connector, comprising:
a main connector part including a housing in which a plurality of contacts are disposed side by side, the housing holding the plurality of contacts; and
a shell to be disposed at least to an outer periphery of the housing, the shell including an opening in which a mating connector is to be inserted, the mating connector being a connection target for the plurality of contacts, wherein
the shell includes an interlocking portion at an edge of the shell opposite to the opening in an insertion direction of the mating connector, the interlocking portion being adapted to restrict mutual movement of the shell and the main connector part along the insertion direction by being engaged with a portion of the main connector part transverse to the insertion direction.

2. The connector according to claim 1, wherein:
the main connector part includes an outer mold to be disposed on a rear end side of the housing, the outer mold being disposed such that relative movement of the outer mold to the housing in the insertion direction is restricted, and
the outer mold is adapted to be engaged with the interlocking portion of the shell to conform to the interlocking portion.

3. The connector according to claim 1, wherein:
the interlocking portion includes a protrusion extending in the insertion direction, and
the protrusion includes a portion formed such that a width of the portion of the protrusion is greater on a front end side than at a base end of the portion of the protrusion, the portion of the protrusion being transverse to the insertion direction.
